(19) United States
(12) Patent Application Publication
(10) Pub. No.: US 2008/0139418 A1
(43) Pub. Date: Jun. 12, 2008

(54) METHOD FOR EXTRACTING HEAVY OIL AND BITUMEN FROM TAR SANDS

(75) Inventors: Kenneth R. Cioletti, Wayne, NJ (US); Mathew Cioletti, Wayne, NJ (US); Ronald Wilen, Paramus, NJ (US)

Correspondence Address: KATTEN MUCHIN ROSENMAN LLP, 575 MADISON AVENUE, NEW YORK, NY, 10022-2585, US

(73) Assignee: UNITED ENERGY CORPORATION, Secaucus, NJ (US)

(21) Appl. No.: 11/931,150

(22) Filed: Oct. 31, 2007

Related U.S. Application Data
(63) Continuation-in-part of application No. 10/643,289, filed on Aug. 19, 2003.
Application No. 10/643,289 is a division of application No. 09/671,701, filed on Sep. 28, 2000, now Pat. No. 6,630,428.

(51) Int. Cl. C09K 8/60

(52) U.S. Cl. 507/261

(57) ABSTRACT

The use of high flash point low vapor pressure compositions for removal of crude oil deposits from tar sands by injection of products in situ or by removal of tar sands and batch processing. Processing equipment is designed for use on these compositions to maximize recovery of deposits and producing clean sand clays or other base materials for re-deposition without further treatment. The compositions consist of solvent based cleaners, solvent emulsion cleaners, and/or water based alkaline cleaners.

### RELATED APPLICATIONS

This application is a Continuation-in-Part of application Ser. No. 10/643,289 filed on Aug. 19, 2003, which is a divisional of application Ser. No. 09/671,701, filed on Sep. 28, 2000, now U.S. Pat. No. 6,630,428.

### FIELD OF THE INVENTION

The invention relates to the use of high flash point, low vapor pressure compositions for injection into tar sand formations to facilitate removal of organic portions of the tar sands. The invention also relates to a composition or a combination of two or more compositions for removal of residues from strip mined tar sands. The compositions are designed to be used in conjunction with processing equipment which will facilitate the removal of deposits from tar sands either in situ or in specially designed equipment to batch treat strip mined tar sands. The bitumen is then treated to obtain a synthetic crude oil therefrom.

### BACKGROUND OF THE INVENTION

Tar sands (also called oil sands or extra heavy oil) is a common name for deposits more properly called bituminous sands. Tar sands are characterized by a matrix of an inorganic base, consisting of silica based sands or clay material which is porous and can be removed by conventional strip mining techniques. These loose deposits are characterized by the relative ease in which the materials can be mined as opposed to solid formations such as oil shale.

The material in the tar sands can vary from very heavy crude oil to almost solid, insoluble bituminous deposits. The method of removing the deposits depends on the nature of the organic portion. Tar sands must be strip mined or if buried at depths greater than 75 meters, made to flow into producing wells by in situ techniques which reduce the oils viscosity using steam and/or solvents. These processes involve the use of large amounts of steam, water and/or solvents and require large amounts of energy to separate the bitumen from the sand.

Tar sands deposits are located in the United States, Russia and various countries in the Middle East. Venezuela and Canada, contain the majority of the worlds' tar sands with an oil content equivalent to the worlds' total reserves of conventional crude.

Tar sands may represent as much as two-thirds of the world total petroleum resources with at least 1.7 trillion barrels in the Canadian Athabasca oil sands and 1.8 trillion barrels in the Venezuelan Orinoco tar sands as compared to 1.75 trillion barrels of conventional oil worldwide. Most Canadian tar sands are located in the major deposits in northern Alberta. The Alberta deposits contain at least 85% of the world total bitumen deposits which are concentrated enough to make them economically recoverable for conversion to oil.

The reserves in Venezuela are located in the eastern portion of the county north of the Orinoco River. This vies with Canada for the largest known accumulation of bitumen in the world. The bitumen deposits in Venezuela are less degraded than the deposits in Canada and also are at a higher temperature which makes extraction by conventional techniques much easier. The basic problem with the deposits are the physical properties. The bitumen is too heavy to be transported by pipeline. Because it is so viscous, it requires dilution to make it transportable by pipelines.

In the past, the cost to mine and produce oil was more expensive than conventional oil production. With the present high prices of crude oil and global demand showing no signs of abating, the mining and refining of tar sands is currently economically feasible. The need exists to produce crude oil from tar sands as cheaply and efficiently as possible and produce a by-product which is clean enough to return to the environment.

Several extraction processes for the recovery of bitumen from tar sands are currently in use. For example, the bitumen in Canada has been extracted from the oil sands by strip mining. The nature of the deposits, make strip mining the most efficient method. There is a top layer of peat over clay and barren sand. The tar sand layers are typically 40 to 60 meters deep sitting on top of flat limestone rock. The deposits are removed by shovel and truck operations and the tar sands are batch treated. Hot water and caustic soda are added to the sand, the resulting slurry is agitated, and the oil is skimmed from the top. This method allows about 75% recovery. The tailings from this process can be further treated by tailings oil recovery units to remove residual water and solids, thereby allowing extraction plants to recover over 90% of the bitumen in the sand. Unfortunately, this method cannot be used for deeper tar sand layers. In situ techniques are necessary to recover deeper oil. It is estimated that around 80% of the Alberta tar sands and almost all of the Venezuelan tar sands are too far below the surface to use open pit mining.

Another method, known as the cold flow technique pumps oil directly out of the sand using progressive cavity pumps. This method works only where the oil is fluid enough to pump and results in recovering only 5-6% of the oil.

Cyclic Steam Stimulation (CSS) is the conventional “huff and puff” method whereby steam is injected into the well at a temperature of 300-400° C. The steam rises and heats the bitumen which loses its viscosity. The well is allowed to sit for days or weeks, then hot oil is pumped out for a period of weeks or months. The process is then repeated. Unfortunately, the “huff and puff” method requires the site to be shut down for weeks to allow pumpable oil to accumulate. In addition to the high cost to inject steam, the CSS method only results in 20-25% recovery.

Steam Assisted Gravity Drainage (SAGD) is a method where two horizontal wells are drilled in the tar sands, one at the bottom of the formation and another five meters above it. The wells are drilled in groups off of central pads. These wells may extend for miles in all directions. Steam is injected into the upper well, thereby melting the bitumen which then flows into the lower well. The resulting liquid oil is subsequently pumped to the surface. Recovery of only up to 60% of the available oil is achievable.

Other methods for the recovery of bitumen from tar sands have been developed which utilize solvent extraction. The Vapor Extraction Process (VAPEX) method is similar to SAGD but instead of steam, solvents are injected into the upper well and the solvent/oil mixture is collected in the lower well. The use of solvents is expensive and can have negative impact on surrounding ground water. Solvent ether has to be recovered by distillation which is energy intensive or use of fresh solvent which is expensive. All methods rely on the bitumen to be liquefiable at high temperatures or soluble in solvents. The solvents are low flash point compositions, are extremely flammable, and carry a fire and/or explosion risk.

Toe-To-Heel Oil Injection combines a vertical air injection well with a horizontal production well. The oil in the reservoir is ignited and the liquefied pyrolysis products are collected in the horizontal well and pumped to the surface. Control of the fire is a major problem with this method.

Each of the above methods have many cost, environmental and safety problems associated with them. For example, the use of large amounts of steam is energy intensive and requires the processing and disposal of large amounts of water. Currently, tar sands extraction and processing requires several barrels of water for each barrel of oil produced. Strip mining and further treatment results in incompletely cleaned sand, which requires further processing, before it can be returned to the environment. Additionally, bitumen which has a very high melting point and low solubility is not extractable by any of these processes. There is a need to use compositions for extracting heavy oil and/or bitumen which are safe and biodegradable.

Thus, there remains a need for efficient, safe and cost-effective methods to improve the recovery of heavy oil and/or bitumen from tar sands.

### SUMMARY OF THE INVENTION

A process and chemical compositions for extracting heavy oil and/or bitumen from tar sands which can be adapted to both surface methods such as strip mining and in situ methods such as horizontal drilling has been invented. The methods and compositions of the invention produce clean sand both in a strip mining operation and in situ extraction.

According to a broad aspect of the present invention, there is provided use of compositions for extracting heavy oil and/or bitumen from tar sands, which are safe and biodegradable.

According to a further broad aspect of the present invention, there is provided methods and compositions for extracting heavy oil and/or bitumen from tar sands that are effective at removing both soluble and insoluble bitumen.

According to a further broad aspect of the present invention, there is provided a process for extraction of heavy oil and/or bitumen from tar sands having a releasing efficiency of greater than 95% in a simplified process.

According to a still further aspect of the present invention, there is provided a process for extraction of heavy oil and/or bitumen from tar sands comprising: providing a slurry comprising, the tar sand, and a non-petroleum liquid releasing composition containing fatty acid methyl esters and lower glycol ethers; and removing paraffins, tars, heavy oil, bitumens and related soils from tar sands.

According to a still further aspect of the present invention, there is provided a method for separating heavy oils and/or bitumen from tar sands by using a chemical release agent comprising about 40 to 99 wt % of a fatty acid alkyl ester blend, and about 1 to 25 wt % of at least one lower alkyl glycol ether.

According to a still further aspect of the present invention, there is provided a method to remove insoluble bitumen from tar sand by using a chemical release agent comprising alkaline water-based cleaning compositions of glycol ethers, buffers, surfactants, wetting agents, and chelating agents; and separating the freed bitumen by air floating, ultrasonic treatment and centrifugation.

According to a still further aspect of the present invention, there is provided a process for the recycling and water-based cleaning compositions to minimize waste and water treatment during heavy oil and/or bitumen extraction from tar sands.

According to a still further aspect of the present invention, there is provided a process for the recycling of an water-based alkaline cleaner for processing of additional bitumen and use of the water-based alkaline cleaner at temperatures from ambient (60°-80° F.) to 160° F.; separating the bitumen by use of ultrasonic agitation, and floatation using compressed air.

The method of the invention involves separation of the released bitumen by cyclone centrifugation. The present invention is also directed to in situ removal of bitumen by horizontal drilling at least two channels. This is followed by use of a 40 to 99 wt % fatty acid alkyl ester blend and about 1 to 25 wt % of at least one lower alkyl glycol ether as a release agent or alternately the use of an alkaline water-based cleaner as a release agent. The alkaline water-based release agent is a water based alkaline cleaner which consists of about 40-70% water with the balance consisting of inorganic buffer, chelating agent, surfactants or wetting agents and one or more glycol ethers. The released bitumen is carried into the drilled channels and pumped to the surface where it is separated by cyclone centrifugation. The centrifuged alkaline cleaner is then pumped down hole to recover additional bitumen.

Other aspects and advantages of the invention will be apparent to those skilled in the art from the following detailed description taken in conjunction with the Figures and the appended claims.

### BRIEF DESCRIPTION OF THE DRAWINGS

FIG. 1 is a block diagram of a method of tar sand bitumen and/or heavy oil recovery according to a typical embodiment of the invention.

FIG. 2 is a schematic flow diagram of the tar sand bitumen and/or heavy oil recovery method for tar sands removed by strip mining.

FIG. 3 is a schematic flow diagram of the tar sand bitumen and/or heavy oil recovery method for tar sand deposits, in situ.

### DETAILED DESCRIPTION OF THE INVENTION

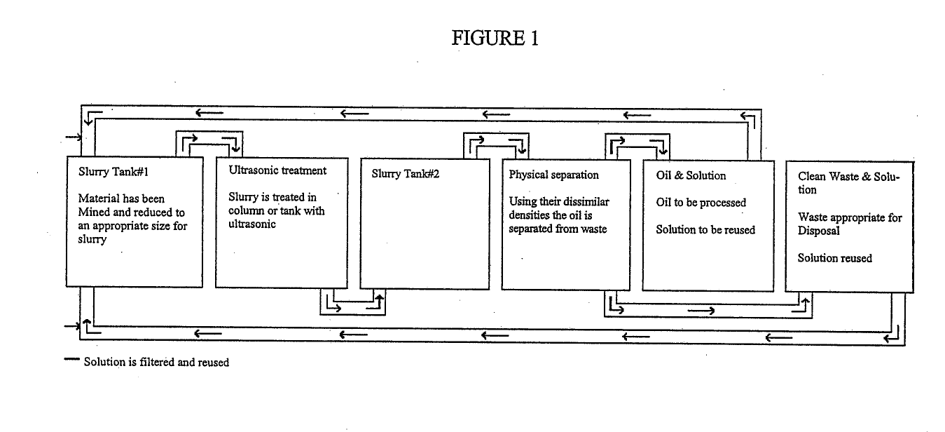

FIG. 1 shows the steps involved in the separation of bitumen and/or heavy oil from tar sands. Those skilled in the art will recognize that before tar sand is ready to be treated it must go through a mechanical process to break large pieces into manageable sizes for processing. That is, the material mined must be reduced to the appropriate size for slurry. This system utilizes a series of pumps, tanks and separation units. Referring to FIG. 1, the sand is conveyed into the first treatment tank (1) where it will undergo the first stage of physical separation. This is done by means of a pump, nozzles and rapid circulation. The mechanical separation creates a slurry of tar sand. The compositions of the present invention are pumped into another tank which finishes the separation of bitumen and/or heavy oil from sand through the use of ultrasonic transducers. The ultrasonic action separates any remaining sand still caught in the bitumen. Screens and perforated sections the second tank are used to separate out the large unmanageable particles and only allow particles of appropriate size to pass on to be separated. Once separated, the particles of appropriate size move into a tank to be kept a slurry (slurry tank #2). From this slurry a separation process taking advantage of the differences in density of the sand bitumen is used to separate the two and requires multiple stages. The separation involves the use of air and/or flow induced forces to cause separation.

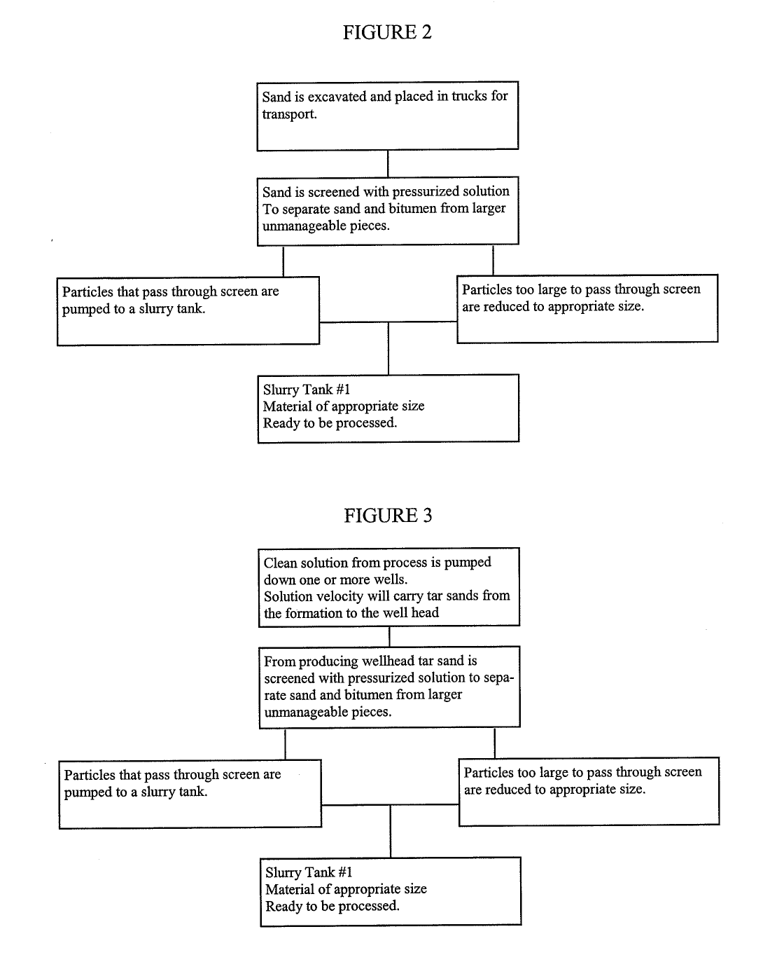

The separation of bitumen and/or heavy oil from tar sands is accomplished by, but not limited to, two methods. Turning to FIG. 2, the batch method is shown. The tar sands are recovered by standard methods such as strip mining and transported to a treatment area. The tar sands are then added to a slurry tank which adds from about 0.5% to about 5% wt/vol. of a release agent by weight of the slurry. The release agent can be a proprietary fatty acid ester blend or a water based alkaline release agent. The treated slurry is then transferred to a treatment tank filled with a diluted (10:1 to 100:1) detergent solution. The detergent solution is a water based alkaline cleaner consisting of surfactants, buffers, chelating agents, glycol ethers, and soil suspending agents. At this point, air is introduced from the bottom of the tank to float off the released bitumen and heavy oils, which float to the top of the tank. The solids on the bottom of the tank are further agitated by the use of ultrasonic transducers. The liquid portion is transferred to cyclonic centrifuges which remove any additional free organic matter. The liquid, which is composed of remaining organics, is then transferred to another flotation tank to treat additional tar sands. The remaining organics are separated physically by taking advantage of wetting characteristics of butimens and density differences of the oil/butimens and tar sands.

By the term viscous, solid or semi solid oils is meant bitumen and/heavy oil.

By the term “cleaning agent” is meant release of bitumen and/or heavy oil, paraffins, tars and related soils from tar sands. Cleaning agents separate the released bitumen and/or heavy oil into a separate liquid or solid phase.

By the term “release agent” or “chemical release agent” is meant an agent that breaks the bonds between the bitumen and/or heavy oil and the sand substrate.

As referred to herein tar sands is defined as a type of oil sand or sandstone from which the lighter fractions of crude oil have escaped, leaving residual asphalt to fill the interstices.

The remaining treated sand at this point still contains some heavy insoluble organic particles. The sand is stirred into the water and allowed to settle creating a top layer of organic bitumen particles and a bottom layer of sands. The top layer is removed by suction and the organic material is separated from the sand by cyclonic centrifugation. The waste sand is dried and returned to a landfill. Processing temperatures range from 70° F. to 160° F., depending on the nature of the organic portion of the tar sands.

Referring to FIG. 3, alternatively, the chemical release agent can be added directly to the tar sand. The second method involves in situ treatment of the sand deposits which are located too deep for strip mining. This method is an adaptation of the vapor extraction process (VAPEX). Instead of solvent, chemical release agent is injected into the tar sands. This is followed by the use of an alkaline water-based extraction liquid which washes the loosened bitumen into the receiving horizontal well bores where it is pumped to the surface.

There are two types of compositions involved in these processes. The first are release agents which can are non-petroleum solvent-based and the second are alkaline water-based.

The solvent-based composition contains ingredients in amounts effective to either dissolve or release heavy oil and/or bituminous deposits from the tar sands. The most effective and preferred composition is a fatty acid alkyl ester blend.

The fatty acid alkyl ester blends useful in compositions of the present invention preferably contain C₁ to C₈ esters of C₄ to C₂₂ fatty acids having the formula:

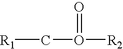

wherein R₁ is to C₂₂ alkyl and R₂ is C₁ to C₈ alkyl. Fatty acid esters are derived from natural products, and thus comprise more than one ester; hence blend. Typically, fatty acid esters are derived from the esterification of fatty acids or the transesterification of animal fats or vegetable oils.

The fatty acid alkyl ester blend more preferably contains methyl, ethyl, n-propyl, isopropyl, or n-butyl esters of C₄ to C₂₂ fatty acids. Most preferably, the fatty acid alkyl ester blend contains methyl esters. The fatty acid methyl ester blends are preferably blends with a cloud point of 40° F. and a high proportion of unsaturation to increase solvency. More preferably, the fatty acid methyl ester blends are derived from soya, canola, and other vegetable oils, with a cloud point of 20°-32° F. and an iodine value of 90-130.

As a penetrant, to reduce viscosity of the mixture, as a coupling agent, and/or to increase efficacy on hydrophilic soils, 1 to 25 wt % of a lower alkyl glycol ether may be added. Examples of lower alkyl glycol ethers useful in the present composition include dipropylene glycol monomethyl ether, tripropylene glycol monomethyl ether, ethylene and diethylene glycol ether, methyl, ethyl, propyl and butyl ethers, such as ethylene glycol monobutyl ether, or mixtures thereof.

A polyoxyalkylene glycol ether may be present in the composition in amounts of about 1 to 40 wt %, preferably 3 to 25 wt %, and more preferably 3 to 10 wt %. The actual amount utilized depends on the types of heavy oil and/or bitumen present and on the water content of the sand. Preferably used are polyethylene glycol ethers and polypropylene glycol ethers having the formulas:

R—O—(C₂H₄O)xH and R—O—(C₃H₆O)xH

where, in each formula, R is C₁ to C₈ alkyl and x is greater than 4. R is preferably methyl, ethyl, propyl, or butyl. More preferably, the polyoxyalkylene glycol ether is an n-butoxy polyalkylene glycol ether. Commercial polyoxyalkylene glycol ether formulations available include MACOL 300, MACOL 660, WSL-2000, WSL-3520, and WSL-5100 (all produced by PPG Mazer, Gurnee, Ill.). The polyoxyalkylene glycol ether preferably has a molecular weight of between about 200 and 600 and a viscosity of between about 15 and 150 cps when measured at 25° C. using a Brookfield LVT Viscometer with a No. 2 spindle at 60 r.p.m.

Preferably, at least 1 wt %, and more preferably, 1.5 to 3 wt %, of antioxidants are included in the composition. Antioxidants suitable for the present invention include, but are not limited to, (BHT) 2,6-di-tert-butyl-para-cresol, (BHA) 2,6-di-tert-butyl-para-anisole, Eastman inhibitor OABM-oxalyl bis(benzylidenehydrazide), and Eastman DTBMA 2,5-di-tert-butylhydroquinone.

A surfactant may also be added to the composition. Any surfactant suitable for use in cleaning oily soils may be used including, but not limited to, ethoxylated nonylphenols, linear alcohol ethoxylates, alkanolamine salts of dodecylbenzene sulfonic acid, sulfosuccinates, phosphate esters, alcohol sulfates, quaternary ammonium compounds, amphoteric surfactants, alpha-olefin sulfonates, sorbitan, and fatty acid derivatives. The surfactant is added in an amount effective to perform as a wetting agent and emulsifier, and usually up to 10 wt %, preferably 1-3 wt %, of the composition.

Commercial solvents include, but are not limited to, the EXXATE series of esters obtained from EXXON. EXXATE 1000 is an acetic acid ester of C₉-C₁₁ branched oxo-alcohol. DBE (DuPont) is a blend of 45-75 wt % dimethyl glutarate, 10-25 wt % dimethyl adipate, and 15-30 wt % dimethyl succinate.

Suitable chelating agents for addition to the chemical release agent include, but are not limited to, EDTA acid and its salts (e.g. sodium, potassium, ammonium), tetrapotassium pyrophosphate, sodium metaphosphate, sodium hexamethaphosphate, and phosphonates such as Dequest® series products such as Dequest® 7000.

Up to 50 wt % of other additives may be added, as needed, for particular applications, such as to vary the volatile organic compound (VOC) levels, increase penetration of the mixture, decrease viscosity of the mixture, as couplers for solvents insoluble in the mixture, and to provide solvents for oleophilic and hydrophilic soils. It is within the skill of one in the art to determine the amount and type of additive needed for a particular application.

Suitable additives include, but are not limited to, terpenes, terpene alcohols, C₈-C₁₄ alcohol ester blends, glycols, acid esters, diacid esters, petroleum hydrocarbons, amino acids, alkanolamines, and amines.

Examples of suitable terpenes include, but are not limited to, d-limonene and α and β pinene and terpene alcohols, including α-terpineol. C₈-C₁₄ alcohol ester blends include EXXATE 900 (a commercial C₉ alkyl acetate), EXXATE 1000 (a commercial C₁₀ alkyl acetate), and EXXATE 1300 (a commercial C₁₃ alkyl acetate) (Exxon Chemical).

Examples of suitable glycols include, but are not limited to, propylene glycol, dipropylene glycol, and dripropylene glycol.

Examples of suitable acid esters include, but are not limited to, methyl oleate and methyl linoleate, and diacid esters include methyl or butyl diesters of glutaric, adipic, and succinic acids.

Suitable petroleum hydrocarbons include, but are not limited to, AROMATIC 100, AROMATIC 150, ISOPAR M, and ISOPAR K (Exxon).

Examples of suitable dibasic esters include, but are not limited to, Dibasic Esters (DBE) (Dupont).

Examples of suitable amines include, but are not limited to, morpholene, 1,3-dimethyl-2-imidazolidinone, 1,3 propanediamine, 2-amino-1,3-propanediol, and 3-amino propanol, and alkanolamines such as triethanolamine, diethanolamine, 2-aminomethyl propanol, and monoethanolamine. Amines act as dispersants for soils and solubilize fatty acids and oils. Examples of suitable amino acids include, but are not limited to, choline and choline hydroxide. These amino acids provide nontoxic alternatives to monoethanolamine and act as metal chelators, preferably, methyl or isobutylesters of C₄-C₆ aliphatic dibasic esters and n-methyl-2 pyrrolidone. Preferably, up to 5 wt % of n-methyl-2 pyrrolidone is included.

Other additives typically present in cleaning compositions may be used, including, but not limited to, water softening agents, sequesterants, and corrosion inhibitors, which are added in amounts effective to perform their intended function. These additives and amounts thereof are well within the skill of the art. Examples of suitable water softening agents include, but are not limited to, linear phosphates, styrene-maleic acid co-polymers, and polyacrylates. Suitable sequesterants include, but are not limited to 1,3-dimethyl-2-imidazolidinone, 1-phenyl-3-isoheptyl-1,3-propanedione, and 2-hydroxy-5-nonylacetophenoneoxime. Nonlimiting examples of suitable corrosion inhibitors include 2-aminomethyl propanol, diethylethanolamine benzotriazole, and methyl benzotriazole.

All additives preferably have a flash point greater than 190° F. (Tag Closed Cup) (TCC) in order to achieve a final composition flash point greater than 200° F. Therefore, the compositions of the invention are environmentally and significantly safer for handling and storage over the low flash point compositions. Additionally, the water based compositions of the invention are not flammable at all and eliminate the fire hazard and/or explosion risk.

The process of the present invention results in recovery of a crude oil type product greater than 95% of the total available hydrocarbon content in the tar sand. This ability to obtain such a high yield obviates the need for a second pass of separation chemicals as is often required to increase the yields of heavy oils and bitumen. Therefore, the invention results in a simplified process.

It is understood that the process of the present invention is not exclusive to tar sands but may be applied to oil shale and wastes produced during the drilling and/or operation of oil wells. This waste can provide crude oil to be processed and then be disposed of properly.

The following examples illustrate certain aspects of the present invention. They are not intended to exemplify the full scope of the invention.

### EXAMPLE 1

The following composition was blended (by weight):

| | |
|---|---|
| Fatty acid methyl ester | 60% |
| n-Butoxy polyalkylene glycol ether | 20% |
| Dipropylene glycol monomethyl ether | 5% |
| Butylcarbitol | 4% |
| EXXATE 1000 (Exxon) | 3% |
| DBE (DuPont) | 3% |
| Tri-propylene glycol monomethyl ether | 3% |
| d-Limonene | 1% |
| Nonylphenol 9.5 Mole E.O. | 1% |

At least 1 wt % of antioxidants selected from one or more of BHT, BHA, and Eastman inhibitor OABM were also added.

### EXAMPLE 2

The following composition was blended (by weight):

| | |
|---|---|
| Fatty acid methyl ester | 67.5% |
| n-Butoxy polyalkylene glycol ether | 20.0% |
| Ethylene glycol monobutyl ether | 4.5% |
| Diethylene glycol monobutyl ether | 1.0% |
| Dipropylene glycol monomethyl ether | 1.0% |
| Tripropylene glycol monomethyl ether | 1.0% |
| EXXATE 900 (Exxon) | 1.0% |
| EXXATE 1000 (Exxon) | 1.0% |
| 1-Methyl 2-pyrrolidinone | 1.0% |
| Dibasic esters | 1.0% |

At least 1 wt % of antioxidants selected from one or more of BHT, BHA, and Eastman inhibitor OABM were also added.

### EXAMPLE 3

The following composition was blended (by weight):

| | |
|---|---|
| Fatty acid methyl ester | 86.0% |
| Nonylphenol (9.5 mole Ethylene Oxide) | 1.5% |
| Nonylphenol (6.0 mole Ethylene Oxide) | 1.5% |
| Ethylene glycol monobutyl ether | 1.0% |
| Diethylene glycol monomethyl ether | 1.0% |
| Dipropylene glycol monomethyl ether | 1.0% |
| Tripropylene glycol monomethyl ether | 1.0% |
| EXXATE 900 (Exxon) | 1.0% |
| EXXATE 1000 (Exxon) | 1.0% |
| EXXATE 3000 (Exxon) | 1.0% |
| 1-Methyl 2-pyrrolidinone | 1.0% |
| Dibasic esters | 1.0% |

At least 1 wt % of antioxidants selected from one or more of BHT, BHA, and Eastman inhibitor OABM were also added. The three compositions were tested on a pilot plant scale.

### EXAMPLE 4

Twenty pounds of tar sands were introduced into a rotary mixer and allowed to blend for 20 minutes. Added to the tar sands was 5% by weight of the chemical release agent used in Example 1. The treated tar sands were transferred to a holding tank containing 200 gallons of diluted detergent (10:1 w/w). The sand was treated ultrasonically for five minutes. The released material was then floated to the top of the tank and removed by skimming. The treated sand was then removed and slurried with 10:1 (w/w) ratio of fresh water. The resulting slurry was subjected to centrifugation to remove the heavy insoluble organic particles from the sand.

### EXAMPLE 5

A second batch of tar sand was treated with an alkaline water-based solution having the following composition:

| | |
|---|---|
| Water | 68% |
| Sodium Carbonate | 10% |
| Potassium Metasilicate | 4% |
| Nonylphenol Ethoxylate- 9 mole | 12% |
| Sodium lauryl sulfate | 4% |
| Tetrasodium EDTA | 2% |

and processed as in Example 4 with similar results.

Over 99% of organic material was removed in Example 4 and 5. A typical water based alkaline cleaner is used concentrated as a release agent and diluted from 5:1 to 10:1 with water as a flotation agent. Typical composition consists of from 40% to 60% water, an EDTA type of chelating agent is also added. The buffering system can be phosphate, silicate, carbonate borate or alkanolamine based. Surfactants, which may be used are ethoxylated alcohols, ethoxylated nonylphenols, amphoteric surfactants, cationic surfactants or alkanolamine/linear alkyl sulfonates/sulfate salts. Coupling agents such as sodium xylene sulfonate, ammonium xylene sulfonate, or phosphate esters are also employed in the composition. Also included are glycol ethers, such as ether used alone or in combination with other glycol ethers.

While this invention has been described as having a preferred design, it is understood that it is capable of further modifications, uses and/or adaptations of the invention, following the general principle of the invention and including such departures from the present disclosure as has come within known or customary practice in the art to which the invention pertains, and as may be applied to the central features hereinbefore set forth, and fall within the scope of the invention of the limits of the appended claims.

I claim:

1. A process for removing viscous, solid or semi solid oils and bitumen from tar sands removed by strip mining in a batch process, said method comprising:
adding to a slurry of tar sands from 0.5 to 5% wt/vol of a chemical release agent selected from the group consisting of a 40 to 99% fatty acid alkyl ester blend and about 1 to 25% of at least one lower alkyl glycol ether, and a water-based alkaline release agent;
transferring the slurry to a tank filled with a 10:1 to 1000:1 (w/w) detergent solution;
applying ultrasonic cleaning to the slurry;
introducing air into the tank to separate the slurry into a solid part of sand and a floating liquid part of oil and bitumen;
transferring the floating liquid part to a cyclonic centrifuge; and
subjecting the floating liquid part to cyclonic centrifuging; wherein said process has a release efficacy of greater than 95%.

2. The process of claim 1, further comprising re-cycling the chemical release agent to treat additional tar sands.

3. A method for removing viscous solid or semi solid oils and bitumen from tar sand deposits in situ, said method comprising:
creating one or more horizontal shafts into tar and sand strata;
introducing a chemical release agent selected from the group consisting of a 40 to 99% fatty acid alkyl ester blend and about 1 to 25% of at least one lower alkyl glycol ether, and a water-based alkaline release agent into the tar sands under pressure from the one or more horizontal shafts;
adding an alkaline water-based cleaning agent into the one or more horizontal shafts; and
removing the alkaline water-based cleaning agent by pumping out of one or more horizontal return shafts, wherein said process has a release efficacy of greater than 95%.

4. The method according to claim 1, wherein the chemical release agent comprises:
about 40 to 99 wt % of a fatty acid alkyl ester blend, the ester blend comprising C₂ to C₈ esters of C₁ to C₂₂ fatty acids having the formula: 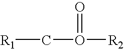
wherein R₁ is to C₂₋₂ alkyl and R₂ is C₁ to C₉ alkyl, and about 1 to 25 wt % of at least one lower alkyl glycol ether; or
an alkaline water-based cleaner, the cleaner comprising 40-70% water, an inorganic or organic buffer, a chelating agent, surfactants and one or more glycol ethers.

5. The method according to claim 4 wherein said fatty acid alkyl ester blend contains esters selected from the group consisting of the methyl esters of soya or canola fatty acid.

6. The method according to claim 1 where said chemical release agent comprises:
(by weight):

| | |
|---|---|
| Fatty acid methyl ester | 60% |
| n-Butoxy polyalkylene glycol ether | 20% |
| Dipropylene glycol monomethyl ether | 5% |
| Butylcarbitol | 4% |
| EXXATE 1000 (Exxon) | 3% |
| DBE (DuPont) | 3% |
| Tri-propylene glycol monomethyl ether | 3% |
| d-Limonene | 1% |
| Nonylphenol 9.5 Mole E.O. | 1% |

7. The method according to claim 1 where said chemical release agent comprises
(by weight):

| | |
|---|---|
| Fatty acid methyl ester | 67.5% |
| n-Butoxy polyalkylene glycol ether | 20.0% |
| Ethylene glycol monobutyl ether | 4.5% |
| Diethylene glycol monobutyl ether | 1.0% |
| Dipropylene glycol monomethyl ether | 1.0% |
| Tripropylene glycol monomethyl ether | 1.0% |
| EXXATE 900 (Exxon) | 1.0% |
| EXXATE 1000 (Exxon) | 1.0% |
| 1-Methyl 2-pyrrolidinone | 1.0% |
| Dibasic esters | 1.0% |

8. The method according to claim 1 where said chemical release agent comprises
(by weight):

| | |
|---|---|
| Fatty acid methyl ester | 86.0% |
| Nonylphenol (9.5 mole Ethylene Oxide) | 1.5% |
| Nonylphenol (6.0 mole Ethylene Oxide) | 1.5% |
| Ethylene glycol monobutyl ether | 1.0% |
| Diethylene glycol monomethyl ether | 1.0% |
| Dipropylene glycol monomethyl ether | 1.0% |
| Tripropylene glycol monomethyl ether | 1.0% |
| EXXATE 900 (Exxon) | 1.0% |
| EXXATE 1000 (Exxon) | 1.0% |
| EXXATE 3000 (Exxon) | 1.0% |
| 1-Methyl 2-pyrrolidinone | 1.0% |
| Dibasic esters | 1.0% |

9. The method according to claim 1, wherein the chemical release agent is added at the rate of 0.5 to 5.0% w/w.

10. The method according to claim 1, wherein the tar sand is added to the tank of 10:1 to 1000:1 (w/w) detergent solution at a ratio of 5:1 to 10:1 w/w.

11. The method according to claim 1, wherein the ultrasonic cleaning is at a temperature of between 60° F. to 180° F.

12. The method according to claim 1, further comprising removal of additional heavy insoluble organics from the sand by slurrying with untreated water and separating by cycloning centrifuging.

13. The method of claim 3, further comprising pumping the chemical release agent to the surface and subjecting chemical release agent to aeration and cyclonic centrifugation to remove solids.

14. The method of claim 3, wherein the chemical release agent is pumped back into the horizontal shafts for reprocessing.

15. The method according to claim 3, wherein the chemical release agent comprises about 40 to 99 wt % of a fatty acid alkyl ester blend, the ester blend comprising C₁ to C₈ esters of C₄ to C₂₂ fatty acids having the formula: 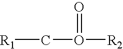
wherein R₁ is to C₂₂ alkyl and R₂ is C₁ to C₈ alkyl, and about 1 to 25 wt % of at least one lower alkyl glycol ether; or
an alkaline water-based cleaner, the cleaner comprising 40-70% water, an inorganic or organic buffer, a chelating agent, surfactants and one or more glycol ethers.

16. The method according to claim 3, wherein said fatty acid alkyl ester blend contains esters selected from the group consisting of the methyl esters of soya or canola fatty acid.

17. The method according to claim 3, wherein the tar sands deposits surrounding the horizontal shafts are subjected to fracking by use of high pressure steam, compressed air or explosives prior to treating with a chemical release agent.

18. The method according to claim 3, wherein the chemical release agent is heated from between 70°-180° C. before pumping down hole.

19. A chemical release agent having a 95% or greater efficacy in extracting bitumen and heavy oil from tar sands, the release agent comprising either:
about 40 to 99 wt % of a fatty acid alkyl ester blend, the ester blend comprising C₁ to C₈ esters of C₄ to C₂₂ fatty acids having the formula: 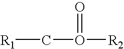
wherein R₁ is to C₂₂ alkyl and R₂ is C₁ to C₈ alkyl, and about 1 to 25 wt % of at least one lower alkyl glycol ether; or
an alkaline water-based cleaner, the cleaner comprising 40-70% water, an inorganic buffer, a chelating agent, surfactants and one or more glycol ethers.

20. The chemical release agent for extracting bitumen and heavy oil from tar sands of claim 19, comprising:
a fatty acid alkyl ester blend contains esters selected from the group consisting of the methyl esters of soya or canola fatty acid and about 1 to 25 wt % of at least one lower alkyl glycol ether.

21. The chemical release agent for extracting bitumen and heavy oil from tar sands of claim 20, comprising:
75% methyl soyate and 3% dipropylene glycol monomethyl ether.
